(19) United States
(12) Patent Application Publication
(10) Pub. No.: US 2025/0162544 A1
(43) Pub. Date: May 22, 2025

(54) LENS CLEANING DEVICE FOR SELF-PROPELLED APPARATUS, AND CHARGING STATION FOR SELF-PROPELLED APPARATUS

(71) Applicant: DREAME TECHNOLOGY (SUZHOU) CO.,LTD., Suzhou (CN)

(72) Inventors: Fei LI, Suzhou (CN); Pengyu WANG, Suzhou (CN); Yao YAO, Suzhou (CN)

(73) Assignee: DREAME TECHNOLOGY (SUZHOU) CO.,LTD., Suzhou (CN)

(21) Appl. No.: 19/030,983

(22) Filed: Jan. 17, 2025

Related U.S. Application Data
(63) Continuation of application No. PCT/CN2023/107420, filed on Jul. 14, 2023.

(30) Foreign Application Priority Data
Jul. 22, 2022 (CN) 202221904438.9
Jul. 22, 2022 (CN) 202221928660.2

(51) Int. Cl. B60S 3/04; B08B 1/30

(52) U.S. Cl. CPC B60S 3/04; B08B 1/30

(57) ABSTRACT

Disclosed are a lens cleaning device for a self-propelled apparatus, and a charging station for a self-propelled apparatus. The lens cleaning device for a self-propelled apparatus includes: a mounting frame; and a cleaning assembly, where the cleaning assembly is movably connected to the mounting frame, an end, far away from the mounting frame, of the cleaning assembly is provided with a cleaning member, and in a case that the cleaning member is pressed by pressing external force, at least the cleaning member moves relative to the mounting frame. The lens cleaning device for a self-propelled apparatus, and the charging station for a self-propelled apparatus can solve the problem that a self-propelled apparatus with a camera device cannot clean the camera device in the prior art. An automatic lens cleaning device and a self-propelled apparatus including the device are further disclosed.

### CROSS-REFERENCE TO RELATED APPLICATION

This application is a continuation of PCT International Application No. PCT/CN2023/107420 filed on Jul. 14, 2023, which claims priority to Chinese Patent Application No. 202221904438.9 filed on Jul. 22, 2022 and Chinese Patent Application No. 202221928660.2 filed on Jul. 22, 2022, the entire contents of each of which are incorporated herein by reference.

### TECHNICAL FIELD

The disclosure belongs to the technical field of camera cleaning, and particularly relates to a lens cleaning device for a self-propelled apparatus, and a charging station for a self-propelled apparatus.

### BACKGROUND

With the unceasing improvement in living conditions and scientific and technological levels, lawn mowers become convenient to use with desirable cleaning effects. Thus, the lawn mowers have gradually replaced manual workers for weeding in life and work. With growing popularity, the lawn mowers with a single weeding function are far from satisfying the demand from users. Some intelligent lawn mowers even can automatically weed plants with camera devices.

At present, the lawn mower with the camera device cannot clean the camera device, and functions of the camera device will be affected dramatically once they are covered with debris such as grass clippings and dirt.

In view of that, it is necessary to overcome the defects in the prior art by improving the prior art.

### SUMMARY

In view of that, the disclosure aims at solving the technical problem that a self-propelled apparatus with a camera device cannot clean the camera device in the prior art.

To solve the technical problem described above, some embodiments of the disclosure provide a lens cleaning device for a self-propelled apparatus. The lens cleaning device for a self-propelled apparatus includes: a mounting frame; and a cleaning assembly, where the cleaning assembly is movably connected to the mounting frame, an end, far away from the mounting frame, of the cleaning assembly is provided with a cleaning member, and in a case that the cleaning member is pressed by pressing external force, at least the cleaning member moves relative to the mounting frame.

In some embodiments, the cleaning assembly includes: a connection portion, where the connection portion is connected to the mounting frame; and a cleaning portion, where one end of the cleaning portion is connected to the connection portion, and the other end of cleaning portion is provided with the cleaning member.

In some embodiments, the connection portion includes a connection shaft, the connection shaft is pivotally connected to the mounting frame, and the cleaning portion is connected to the connection shaft.

In some embodiments, the connection portion further includes a resetting member, and the resetting member at least abuts between the cleaning portion and the mounting frame, to provide resetting force for the cleaning portion.

In some embodiments, the cleaning portion includes a first section and a second section that are connected in sequence, an end, far away from the second section, of the first section is connected to the connection shaft, the second section is provided with the cleaning member, and the first section is arranged at an angle relative to the second section.

In some embodiments, an included angle between the first section and the second section is greater than 90 degrees; the second section is provided with the cleaning member on a surface of an area where the first section and the second section form the included angle; an included angle between the second section and a vertical direction is greater than 0 degree and less than or equal to 45 degrees; and the first section extends in the vertical direction.

In some embodiments, the cleaning assembly includes: a drive portion, where the drive portion is in driving connection to the cleaning member and drives the cleaning member to rotate; and a detection portion, where the detection portion is connected to the drive portion.

In some embodiments, the cleaning assembly includes: a water storage tank, where the water storage tank is arranged on the mounting frame; the cleaning member is a cleaning cloth, and a cleaning liquid is contained in the water storage tank; and one end of the cleaning cloth is arranged on the water storage tank and soaked in the cleaning liquid, and the other end of the cleaning cloth is suspended below the water storage tank under the action of gravity.

In some embodiments, a length and/or a width of the cleaning member are/is greater than a diameter of a lens.

In some embodiments, the mounting frame includes a support section and a connection section that are connected in sequence; the connection section is located above the support section, and the support section extends in the vertical direction; and an included angle is formed between the connection section and a horizontal direction, and the cleaning assembly is connected to the connection section and is suspended below the connection section.

The disclosure further provides a charging station for a self-propelled apparatus. The charging station for a self-propelled apparatus includes: a charging station body; and the lens cleaning device for a self-propelled apparatus described above, where the charging station body is arranged on a mounting frame of the lens cleaning device for a self-propelled apparatus.

A technical solution according to the disclosure has the follow advantages:

The lens cleaning device for a self-propelled apparatus in the disclosure includes the mounting frame and the cleaning assembly. The cleaning assembly is movably connected to the mounting frame, the end, far away from the mounting frame, of the cleaning assembly is provided with the cleaning member, and in a case that the cleaning member is pressed by pressing external force, at least the cleaning member moves relative to the mounting frame.

It can be seen from the contents described above that when the lens cleaning device for a self-propelled apparatus in the disclosure is used, in a case that the self-propelled apparatus is parked below the mounting frame, the self-propelled apparatus can press against the mounting frame or a camera device of the self-propelled apparatus can come into contact with the cleaning member during movement, such that the cleaning member can clean the camera device of the self-propelled apparatus. Thus, the lens cleaning device for a self-propelled apparatus in the disclosure effectively solves the problem that the self-propelled apparatus with the camera device cannot clean the camera device in the prior art.

With the unceasing improvement in living conditions and scientific and technological levels, lawn mowers become convenient to use with desirable cleaning effects. Thus, the lawn mowers have gradually replaced manual workers for weeding in life and work. With growing popularity, the lawn mowers with a single weeding function are far from satisfying the demand from users. Some intelligent lawn mowers even can automatically weed plants with camera devices.

At present, the lawn mower with the camera device cannot clean the camera device, and functions of the camera device will be affected dramatically once they are covered with debris such as grass clippings and dirt.

In view of that, it is necessary to overcome the defects in the prior art by improving the prior art.

In view of that, the disclosure aims at solving the technical problem that the self-propelled apparatus with the camera device cannot clean the camera device in the prior art.

To solve the technical problem described above, the disclosure provides an automatic lens cleaning device. The automatic lens cleaning device includes: a lens body; a drive assembly; and a cleaning assembly, where at least part of the cleaning assembly is arranged in a circumferential direction of the lens body, a side, facing the lens body, of the at least part of the cleaning assembly is provided with a cleaning member, the drive assembly is in driving connection to the cleaning assembly to cause at least the cleaning member of the cleaning assembly to move relative to the lens body, and the cleaning member of the cleaning assembly cleans a lens surface of the lens body.

In some embodiments, the automatic lens cleaning device further includes a mounting seat, where the lens body and the cleaning assembly are arranged on the mounting seat.

In some embodiments, the cleaning assembly is movably arranged on the mounting seat, the drive assembly drives the cleaning assembly to move along a preset path, and in a case that the cleaning assembly moves along the preset path, at least part of the cleaning assembly comes into contact with different positions of the lens body.

In some embodiments, two ends of the cleaning assembly are slidably connected to the mounting seat, to cause the drive assembly to drive the cleaning assembly to slide relative to the mounting seat.

In some embodiments, two ends of the cleaning assembly are connected to the mounting seat, and the drive assembly drives the cleaning assembly to rotate relative to the mounting seat.

In some embodiments, a connection line of the two ends, connected to the mounting seat, of the cleaning assembly passes through a circle center of the lens body.

In some embodiments, a rotation angle of the cleaning assembly is greater than or equal to 120 degrees.

In some embodiments, a distance between an end, close to the lens body, of the cleaning member and the lens body is less than or equal to 5 mm.

In some embodiments, the cleaning assembly further includes a base portion, two ends of the base portion are rotatably connected to the mounting seat, and the cleaning member is arranged at a side, facing the lens body, of the base portion and extends towards the lens body.

In some embodiments, a surface of the side, on which the cleaning member is mounted, of the base portion is a camber, and a diameter of the camber is greater than a diameter of the lens body.

The disclosure further provides a self-propelled apparatus. The self-propelled apparatus includes the automatic lens cleaning device described above.

A technical solution according to the disclosure has the follow advantages:

The automatic lens cleaning device in the disclosure includes the lens body, the drive assembly, and the cleaning assembly. The at least part of the cleaning assembly is arranged in the circumferential direction of the lens body, the side, facing the lens body, of the at least part of the cleaning assembly is provided with the cleaning member, the drive assembly is in driving connection to the cleaning assembly to cause at least the cleaning member of the cleaning assembly to move relative to the lens body, and the cleaning member of the cleaning assembly cleans the lens surface of the lens body.

It can be seen from the content described above that when the automatic lens cleaning device in the disclosure is used, the cleaning assembly can be driven to move through the drive assembly since the automatic lens cleaning device is provided with the drive assembly and the cleaning assembly that are in driving connection. That is, the at least part of the cleaning assembly can move relative to the lens body under the action of the drive assembly in the disclosure. Thus, when the drive assembly drives the cleaning assembly to move relative to the lens body, the cleaning member of the cleaning assembly can clean the lens body, thus guaranteeing that the surface of the lens body is not covered with dirt. Thus, the automatic lens cleaning device in the disclosure effectively solves the problem that the self-propelled apparatus with the camera device cannot clean the camera device in the prior art.

### BRIEF DESCRIPTION OF THE DRAWINGS

In order to more clearly describe technical solutions in specific implementations of the disclosure or in the prior art, a brief introduction to accompanying drawings required for the description of the specific implementations or the prior art will be provided below. Apparently, the accompanying drawings in the following description show some implementations of the disclosure, and those of ordinary skill in the art can still derive other accompanying drawings from these accompanying drawings without creative efforts.

FIG. 1 is a schematic structural diagram of a lens cleaning device for a self-propelled apparatus according to Embodiment 1 of the disclosure;

FIG. 2 is a schematic diagram of a positional relationship between a mounting frame and a cleaning assembly of the lens cleaning device for a self-propelled apparatus according to Embodiment 1 of the disclosure;

FIG. 3 is a schematic structural diagram of a lens cleaning device for a self-propelled apparatus according to Embodiment 3 of the disclosure;

FIG. 4 is a schematic structural diagram of an automatic lens cleaning device according to Embodiment 1 of the disclosure; and

FIG. 5 is a schematic diagram of a positional relationship between a lens body and a cleaning assembly of the automatic lens cleaning device according to Embodiment 1 of the disclosure.

### DESCRIPTION OF REFERENCE NUMERALS

110-mounting frame; 111-support section; 112-connection section; 120-cleaning assembly; 121-cleaning member; 122-connection portion; 1221-connection shaft; 1222-resetting member; 123-cleaning portion; 1231-first section; 1232-second section; 124-water storage tank; and 130-charging station body.
210-lens body; 211-convex edge; 220-cleaning assembly; 221-cleaning member; 222-base portion; and 230-mounting seat.

### DETAILED DESCRIPTION

The technical solutions of the disclosure will be described below clearly and comprehensively in conjunction with accompanying drawings. Apparently, embodiments described are merely some embodiments rather than all embodiments of the disclosure. The disclosure will be described in detail below with reference to the accompanying drawings and in conjunction with the embodiments. It should be noted that the embodiments in the disclosure and features in the embodiments can be combined mutually if there is no conflict.

It should be noted that the terms “first”, “second”, etc. in the description, the claims and the accompanying drawings of the disclosure are used to distinguish similar objects, but are not necessarily used to describe a specific sequence or a sequential order.

In the disclosure, the orientation words such as “up, down, top and bottom” usually indicate the directions shown in the accompanying drawings, or the vertical direction, the perpendicular direction or the gravity direction of the part itself unless otherwise stated. Similarly, for the convenience of understanding and description, “inside and outside” indicate the inside and the outside of the outline of each part itself, but the above orientation words are not used to limit the disclosure.

The disclosure solves the problem that a self-propelled apparatus with a camera device cannot clean the camera device in the prior art.

It should be noted that in the following embodiments of the disclosure, a self-propelled apparatus refers to a lawn mower, and a charging station for the self-propelled apparatus refers to a lawn mower charging station matching the lawn mower.

That is, in the following embodiments of the disclosure, a camera device on the lawn mower is cleaned when the lawn mower enters the lawn mower charging station.

It is clear that the self-propelled apparatus in the disclosure may alternatively be another self-propelled apparatus.

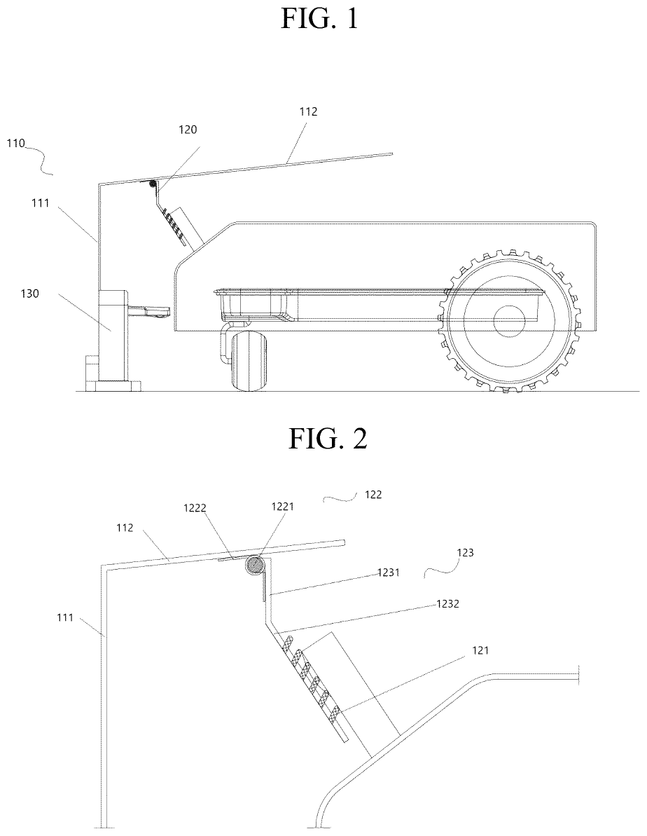

As shown in FIG. 1 and FIG. 2, a lens cleaning device for a self-propelled apparatus in this embodiment includes a mounting frame 110 and a cleaning assembly 120. The cleaning assembly 120 is movably connected to the mounting frame 110, an end, far away from the mounting frame 110, of the cleaning assembly 120 is provided with a cleaning member 121, and in a case that the cleaning member 121 is pressed by pressing external force, at least the cleaning member 121 moves relative to the mounting frame 110.

When the lens cleaning device for a self-propelled apparatus in the disclosure is used, in a case that the self-propelled apparatus is parked below the mounting frame 110, the self-propelled apparatus can press against the mounting frame 110 or a camera device of the self-propelled apparatus can come into contact with the cleaning member 121 during movement, such that the cleaning member 121 can clean the camera device of the self-propelled apparatus. Thus, the lens cleaning device for a self-propelled apparatus in the disclosure effectively solves the problem that the self-propelled apparatus with the camera device cannot clean the camera device in the prior art.

That is, when the self-propelled apparatus, that is, the lawn mower in this embodiment, needs to be charged or the camera device of the lawn mower needs to be cleaned since the camera device is covered with grass clippings or dirt, the lawn mower can be moved towards the mounting frame 110, and a lens of the camera device of the lawn mower can come into contact with the cleaning member 121 during the movement of the lawn mower. In addition, with continuous movement of the lawn mower, the lens can press against the cleaning member 121, such that the cleaning member 121 of the cleaning assembly 120 can move relative to the mounting frame 110, and part, abutting against the lens, of the cleaning member 121 can rub against the lens to remove the grass clippings or dirt covering a lens surface.

In addition, it should be pointed out that in the disclosure, a side, in contact with the lens, of the cleaning member 121 is provided with soft bristles.

In an embodiment, the cleaning assembly 120 in this embodiment includes a connection portion 122 and a cleaning portion 123. The connection portion 122 is connected to the mounting frame 110. One end of the cleaning portion 123 is connected to the connection portion 122, and the other end of cleaning portion 123 is provided with the cleaning member 121. In addition, the connection portion 122 includes a connection shaft 1221, the connection shaft 1221 is pivotally connected to the mounting frame 110, and the cleaning portion 123 is connected to the connection shaft 1221. With this arrangement, it can be guaranteed that the connection shaft 1221 of the connection portion 122 can rotate relative to the mounting frame 110 when the lens of the camera device abuts against the cleaning member 121 and presses against the cleaning member 121. Thus, the cleaning portion 123 can drive the cleaning member 121 to rotate along with the connection shaft 1221, and the bristles of the cleaning member 121 rubs against with a contact surface of the lens, to clean the lens.

In an embodiment, the connection portion 122 further includes a resetting member 1222, and the resetting member 1222 at least abuts between the cleaning portion 123 and the mounting frame 110, to provide resetting force for the cleaning portion 123.

In an embodiment, the resetting member 1222 is a torsion spring preferably. In this embodiment, the connection shaft 1221 passes through the torsion spring, and the torsion spring abuts against the mounting frame 110 and the cleaning portion 123. With this arrangement, the resetting force is provided for the connection shaft 1221 or the cleaning portion 123, and friction force between the bristles of the cleaning member 121 and the contact surface of the lens can be further increased by setting the torsion spring, thus improving a cleaning effect of the lens.

In an embodiment, the cleaning portion 123 includes a first section 1231 and a second section 1232 that are connected in sequence, an end, far away from the second section 1232, of the first section 1231 is connected to the connection shaft 1221, the second section 1232 is provided with the cleaning member 121, and the first section 1231 is arranged at an angle relative to the second section 1232. With this arrangement, the cleaning member 121 can better attach to the lens surface, and a better cleaning effect is achieved. Thus, in this embodiment, an included angle between the first section 1231 and the second section 1232 mainly matches a mounting angle of the lens on the lawn mower.

In an embodiment, the included angle between the first section 1231 and the second section 1232 is greater than 90 degrees.

In an embodiment, the second section 1232 is provided with the cleaning member 121 on a surface of an area where the first section 1231 and the second section 1232 form the included angle.

In an embodiment, an included angle between the second section 1232 and a vertical direction is greater than 0 degree and less than or equal to 45 degrees.

In an embodiment, the first section 1231 extends in the vertical direction.

In an embodiment, a length and a width of the cleaning member 121 are greater than a diameter of a lens. With such arrangement, it can be guaranteed that the cleaning member 121 can come into contact with the lens more comprehensively, thus obtaining the better cleaning effect. A plurality of cleaning members 121 may be provided certainly, different cleaning members 121 vary in length and width, and different cleaning members 121 may adapt to different lenses accordingly. Thus, in this embodiment, the case that the length and the width of the cleaning member 121 are greater than the diameter of the lens generally indicates that the length and the width of a selected cleaning member 121 need to be greater than the diameter of a lens to be cleaned.

In an embodiment, the mounting frame 110 includes a support section 111 and a connection section 112 that are connected in sequence. The connection section 112 is located above the support section 111, and the support section 111 extends in the vertical direction. An included angle is formed between the connection section 112 and a horizontal direction, and the cleaning assembly 120 is connected to the connection section 112 and is suspended below the connection section 112. That is, in this embodiment, a space for parking the lawn mower is provided below the connection section 112, such that it can be guaranteed that the lawn mower can move forward continuously after entering a position below the connection section 112, and the cleaning member 121 is caused to rub against the lens surface.

This embodiment is different from the embodiment described above in that in this embodiment, the cleaning assembly 120 further includes a drive portion and a detection portion. The drive portion is in driving connection to the cleaning member 121 and drives the cleaning member 121 to rotate. The detection portion is connected to the drive portion. With this arrangement, after the detection portion detects that the lens surface is in contact with the bristles of the cleaning member 121, a signal can be transmitted to the drive portion. Thus, the drive portion can drive the cleaning member 121 to rotate, to better clean the lens.

In an embodiment, the detection portion is a contact sensor or an infrared sensor.

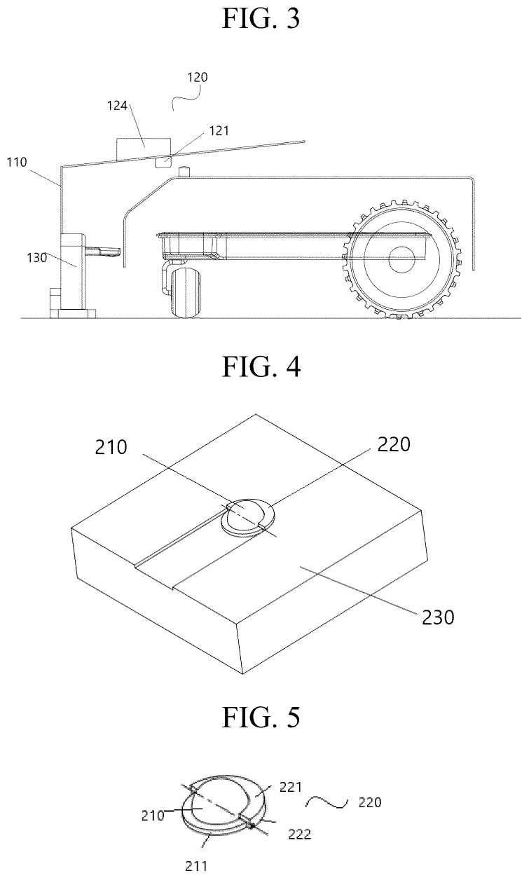

As shown in FIG. 3, this embodiment is different from the embodiment described above in that in this embodiment, the cleaning assembly 120 includes: a water storage tank 124, where the water storage tank 124 is arranged on the mounting frame 110. The cleaning member 121 is a cleaning cloth, and a cleaning liquid is contained in the water storage tank 124. One end of the cleaning cloth is arranged on the water storage tank 124 and soaked in the cleaning liquid, and the other end of the cleaning cloth is suspended below the water storage tank 124 under the action of gravity. That is, in this embodiment, the cleaning assembly 120 does not clean the lens of the camera device through a brush. Instead, when the lawn mower moves to a position below the mounting frame 110, the cleaning cloth comes into contact with the lens, and the lens can be wiped by the cleaning cloth along with the movement of the lawn mower. In addition, in this embodiment, the cleaning liquid may be water. The water in the water storage tank 124 can permeate the cleaning cloth, such that the cleaning cloth can be kept moist to guarantee the cleaning effect of the lens.

In this embodiment, a lower surface of the cleaning cloth is lower than a highest point of the lens with a drop not more than 5 mm. When the machine enters the charging station, the lens is in contact with the cleaning cloth. When the machine moves forward, the cleaning cloth completely wipes the lens surface and removes the grass clippings and the dirt on the lens.

As shown in FIG. 1 and FIG. 3, this embodiment provides a charging station for a self-propelled apparatus. The charging station includes a charging station body 130 and the lens cleaning device for a self-propelled apparatus of the embodiment described above. The charging station body 130 is arranged on a mounting frame 110 of the lens cleaning device for a self-propelled apparatus.

It can be seen from the description that the embodiment described above of the disclosure achieves the following technical effects:
1. The problem that the self-propelled apparatus with the camera device cannot clean the camera device in the prior art is effectively solved.
2. The performance is stable.
3. A structure is simple and disassembly is convenient.

Apparently, the embodiments described above are merely some embodiments rather than all embodiments of the disclosure. Based on the embodiments of the disclosure, other changes or modifications in different forms can be made by those of ordinary skill in the art without creative efforts and should fall within the protection scope of the disclosure.

It should be noted that in the following embodiment of the disclosure, a self-propelled apparatus refers to a lawn mower.

That is, in the following embodiment of the disclosure, an automatic lens cleaning device of the disclosure may be mounted on the lawn mower.

It is clear that the self-propelled apparatus in the disclosure may alternatively be another self-propelled apparatus.

As shown in FIG. 4 and FIG. 5, the automatic lens cleaning device in this embodiment includes a lens body 210, a drive assembly, and a cleaning assembly 220. At least part of the cleaning assembly 220 is arranged in a circumferential direction of the lens body 210, a side, facing the lens body 210, of the at least part of the cleaning assembly 220 is provided with a cleaning member 221, the drive assembly is in driving connection to the cleaning assembly 220 to cause at least the cleaning member 221 of the cleaning assembly 220 to move relative to the lens body 210, and the cleaning member 221 of the cleaning assembly 220 cleans a lens surface of the lens body 210.

It can be seen from the content described above that when the automatic lens cleaning device in the disclosure is used, the cleaning assembly 220 can be driven to move through the drive assembly since the automatic lens cleaning device is provided with the drive assembly and the cleaning assembly 220 that are in driving connection. That is, the at least part of the cleaning assembly 220 can move relative to the lens body 210 under the action of the drive assembly in the disclosure. Thus, when the drive assembly drives the cleaning assembly 220 to move relative to the lens body 210, the cleaning member 221 of the cleaning assembly 220 can clean the lens body 210, thus guaranteeing that the surface of the lens body 210 is not covered with dirt. Thus, the automatic lens cleaning device in the disclosure effectively solves the problem that the self-propelled apparatus with the camera device cannot clean the camera device in the prior art.

That is, when the camera device of the self-propelled apparatus, that is, the lawn mower in this embodiment is covered with the grass clippings or the dirt and needs to be cleaned, the drive assembly can be controlled to drive the cleaning assembly 220 to move, the cleaning member 221 can move relative to the surface of the lens body 210, and the cleaning member 221 can remove the grass clippings and the dirt on the surface of the lens body 210. Thus, an automatic navigation effect of the lawn mower is guaranteed.

It should be noted that in this embodiment, the drive assembly may include a drive motor arranged inside the lawn mower, and the cleaning member 221 of the cleaning assembly 220 is driven by the driving motor to move relative to the lens body 210.

In an embodiment, the automatic lens cleaning device further includes a mounting seat 230. The lens body 210 and the cleaning assembly 220 are arranged on the mounting seat 230. Since the automatic lens cleaning device is arranged on the lawn mower in this embodiment, stability between the lens body 210 and the cleaning assembly 220 can be effectively ensured by arranging the mounting seat 230. In an embodiment, it can be guaranteed that the cleaning assembly 220 can clean the lens body 210 in a preset direction, and can be prevented from inclining during the movement of the cleaning assembly 220 relative to the lens body 210. In addition, by arranging the mounting seat 230, a mounting position can be further provided for the automatic lens cleaning device when mounted on the lawn mower.

In an embodiment, the cleaning assembly 220 is movably arranged on the mounting seat 230, the drive assembly drives the cleaning assembly 220 to move along a preset path, and in a case that the cleaning assembly 220 moves along the preset path, at least part of the cleaning assembly 220 comes into contact with different positions of the lens body 210. With this arrangement, it can be guaranteed that the cleaning assembly 220 can clean an exposed portion of the lens body 210 in all directions, to better clean the surface of the lens body 210, and the cleaning effect of the automatic lens cleaning device is further guaranteed.

In this embodiment, two ends of the cleaning assembly 220 are connected to the mounting seat 230, and the drive assembly drives the cleaning assembly 220 to rotate relative to the mounting seat 230. In addition, in this embodiment, the exposed portion of the lens body 210 is hemispherical, and the cleaning assembly 220 cleans the exposed hemispherical portion of the lens body 210. That is, in this embodiment, when the drive assembly drives the cleaning assembly 220 to move relative to the lens body 210, the cleaning member 221 of the cleaning assembly 220 can clean the exposed surface of the lens body 210, and the movement path of the cleaning member 221 corresponds to the hemispherical surface of the lens body 210. In other words, in this embodiment, when the drive assembly drives the cleaning assembly 220 to rotate relative to the mounting seat 230, the cleaning assembly 220 rotates along an outer surface of the exposed hemispherical surface of the lens body 210, thus forming the movement path of the hemispherical surface.

In an embodiment, the cleaning assembly 220 further includes a base portion 222, two ends of the base portion 222 are rotatably connected to the mounting seat 230, and the cleaning member 221 is arranged at a side, facing the lens body 210, of the base portion 222 and extends towards the lens body 210. That is, in this embodiment, the drive assembly is in driving connection to the base portion 222 and can drive the base portion 222 to rotate relative to the lens body 210, such that the base portion 222 can drive the cleaning member 221 to move relative to the lens body 210, and then the cleaning member 221 can clean the exposed surface of the lens body 210 during movement.

In this embodiment, the cleaning member 221 may be soft bristles arranged on the base portion 222.

In an embodiment, a surface of the side, on which the cleaning member 221 is mounted, of the base portion 222 is a camber, and a diameter of the camber is greater than a diameter of the lens body 210. With this arrangement, a better attaching effect can be guaranteed between the cleaning member 221 and the lens body 210, such that the exposed surface of the lens body 210 can be cleaned more effectively.

In this embodiment, the periphery, close to the two ends of the base portion 222, of the lens body 210 is provided with convex edges 211, and the base portion 222 is arranged around the convex edge 211 when the base portion 222 is not moving. A height of the base portion 222 is higher than a height of the convex edge 211, thus guaranteeing that the cleaning member 221 is located above the convex edge 211 and the cleaning member 221 can clean the surface of the lens body 210 during movement of the base portion 222.

In an embodiment, a distance between an end, close to the lens body 210, of the cleaning member 221 and the lens body 210 is less than or equal to 5 mm. In this embodiment, the self-propelled apparatus is the lawn mower, and the lens surface of the lawn mower is generally covered with the grass clippings or the dirt, the cleaning member 221 can clean the grass clippings and the dirt off the surface of the lens body 210 even if there is a gap between the cleaning member 221 and the outer surface of the lens body 210. In addition, this arrangement can effectively prevent the cleaning member 221 from causing wear on the surface of the lens body 210.

In an embodiment, a rotation angle of the cleaning assembly 220 is greater than or equal to 120 degrees. In this embodiment, the rotation angle of the cleaning assembly 220 mainly depends on a photographing angle of the lens body 210. Thus, the rotation angle of the cleaning assembly 220 can be changed according to an actual photographing angle of the lens body 210, thus guaranteeing that the lens body 210 is not covered by the grass clippings and the dirt during photographing.

In an embodiment, a connection line of the two ends, connected to the mounting seat 230, of the cleaning assembly 220 passes through a circle center of the lens body 210. With this arrangement, it can be effectively guaranteed that the cleaning assembly 220 does not collide with the lens body 210 except cleaning during movement of the cleaning assembly 220 relative to the lens body 210, such that stable operation of the cleaning assembly 220 is guaranteed.

It should be noted that the movement of the cleaning assembly relative to the lens body adopts a movement form that the lens remains stationary, while the cleaning assembly rotates relative to the lens body. Thus, the lens body is cleaned by the cleaning assembly.

In this embodiment, when the drive assembly drives the cleaning assembly to move relative to the lens body, the cleaning assembly further moves linearly on the mounting seat at the same time. In addition, during the movement of the cleaning assembly, the cleaning member of the cleaning assembly passes through different portions of the exposed surface of the lens body in turn, and cleans the lens body accordingly. Thus, in this embodiment, the two ends of the cleaning assembly are slidably connected to the mounting seat, to cause the drive assembly to drive the cleaning assembly to slide relative to the mounting seat.

In an embodiment, in this embodiment, the drive assembly may include a drive motor and a stretchable rod in driving connection to the drive motor. The drive motor drives the stretchable rod to stretch and retract, to cause the stretchable rod to drive the cleaning assembly to slide on the mounting seat.

It is clear that in this embodiment, in addition to the drive method by which the cleaning assembly is driven to slide relative to the mounting seat by the stretchable rod, another drive connection structure may alternatively be used by the drive assembly, as long as the cleaning assembly can slide relative to the mounting seat.

In the embodiment described above, timing for the drive assembly to drive the cleaning assembly to move may be determined as follows: an operator controls the drive assembly to drive the cleaning assembly to move according to observation of the lens body.

In this embodiment, the automatic lens cleaning device can implement determination according to an image shot by the lens body, and the drive assembly can control the cleaning assembly to clean the lens body according to a determination result. Thus, in this embodiment, the automatic lens cleaning device further includes a control assembly. The control assembly is in signal connection to the lens body and the drive assembly. In addition, the control assembly is configured to receive an image signal from the lens body, and the control assembly may determine whether to control the drive assembly to drive the cleaning assembly to move according to the image signal.

It should be noted that in the embodiment of the disclosure, when the drive assembly drives the cleaning assembly to move, a movement form of the cleaning assembly is reciprocating. In addition, a number of reciprocating movements of the cleaning assembly may be adjusted according to the actual use. Alternatively, the number of reciprocating movements of the cleaning assembly may be changed according to cleanliness of the lens body.

It can be seen from the description that the embodiment described above of the disclosure achieves the following technical effects:
1. The problem that the self-propelled apparatus with the camera device cannot clean the camera device in the prior art is effectively solved.
2. The performance is stable.
3. A structure is simple and disassembly is convenient.

Apparently, the embodiments described above are merely some embodiments rather than all embodiments of the disclosure. Based on the embodiments of the disclosure, other changes or modifications in different forms can be made by those of ordinary skill in the art without creative efforts and should fall within the protection scope of the disclosure.

What is claimed is:

1. An automatic lens cleaning device for a lawn mower, comprising:
a lens body;
a drive assembly; and
a cleaning assembly, wherein a side, facing the lens body, of the cleaning assembly is further provided with a cleaning member, and the drive assembly is connected to the cleaning assembly to cause the cleaning member and the lens body to move relative to each other.

2. The automatic lens cleaning device for a lawn mower according to claim 1, further comprising a mounting seat, wherein the lens body and the cleaning assembly are arranged on the mounting seat.

3. The automatic lens cleaning device for a lawn mower according to claim 2, wherein the cleaning assembly is movably connected to the mounting seat.

4. The automatic lens cleaning device for a lawn mower according to claim 2, wherein the drive assembly drives the cleaning assembly to rotate relative to the mounting seat.

5. The automatic lens cleaning device for a lawn mower according to claim 4, wherein the drive assembly drives the cleaning assembly to move along a preset path, and at least part of the cleaning assembly cleans different positions of the lens body.

6. The automatic lens cleaning device for a lawn mower according to claim 4, wherein a distance between a side, close to the lens body, of the cleaning member and the lens body is less than or equal to 5 mm.

7. The automatic lens cleaning device for a lawn mower according to claim 4, wherein the cleaning assembly further comprises a base portion, the base portion is rotatably connected to the mounting seat, and the cleaning member is arranged at a side, facing the lens body, of the base portion and extends towards the lens body.

8. The automatic lens cleaning device for a lawn mower according to claim 1, wherein at least part of the cleaning assembly is arranged in a circumferential direction of the lens body, and the cleaning member cleans a lens surface of the lens body.

9. The automatic lens cleaning device for a lawn mower according to claim 1, wherein a rotation angle of the cleaning assembly is greater than or equal to 120 degrees.

10. An automatic cleaning system for a lawn mower, comprising:
a lens body;
a drive assembly; and
a cleaning assembly, wherein a side, facing the lens body, of the cleaning assembly is further provided with a cleaning member; and
a control assembly, wherein the control assembly is electrically connected to the lens body and the drive assembly, and the control assembly is configured to receive an image signal from the lens body, and implement determination according to the image signal, to control the drive assembly to drive or not to drive the cleaning assembly to move.

11. The automatic cleaning system according to claim 10, wherein the cleaning assembly reciprocates relative to the lens body under the action of driving of the drive assembly.

12. The automatic cleaning system according to claim 11, wherein a number of reciprocating movements of the cleaning assembly is related to cleanliness of the lens body.

13. A lens cleaning device for a lawn mower, comprising:
a mounting frame; and
a cleaning assembly, wherein the cleaning assembly is movably connected to the mounting frame, a side, far away from the mounting frame, of the cleaning assembly is provided with a cleaning member, and at least part of the cleaning member moves relative to the mounting frame.

14. The lens cleaning device for a lawn mower according to claim 13, wherein the cleaning assembly further comprises:
a connection portion, wherein the connection portion is connected to the mounting frame; and
a cleaning portion, wherein one end of the cleaning portion is connected to the connection portion, and the other end of cleaning portion is provided with the cleaning member.

15. The lens cleaning device for a lawn mower according to claim 14, wherein the cleaning portion comprises a first section and a second section that are connected in sequence, an end, far away from the second section, of the first section is connected to the connection portion, the second section is provided with the cleaning member, and the first section is arranged at an angle relative to the second section.

16. The lens cleaning device for a lawn mower according to claim 15, wherein
the first section extends in a vertical direction, and the cleaning member is arranged on a surface, facing the first section, of the second section; and
an included angle between the first section and the second section is greater than 90 degrees, and an included angle between the second section and the vertical direction is greater than 0 degree and less than or equal to 45 degrees.

17. A charging station for a lawn mower, used to charge the lawn mower and clean a lens, comprising:
a charging station body; and
a lens cleaning device for a lawn mower comprising a cleaning assembly; wherein
a side, facing the lens of the lawn mower, of the cleaning assembly is provided with bristles, and in a case that the lawn mower moves relative to the charging station for the lawn mower, the cleaning assembly is capable of coming into contact with the lens, to remove grass clippings or dirt from a lens surface.
